(19) United States
(12) Patent Application Publication
(10) Pub. No.: US 2016/0060846 A1
(43) Pub. Date: Mar. 3, 2016

(54) Method of Controlling Work of Excavator

(71) Applicants: Ho Youn LEE, Seoul (KR); Jong Hyung YIM, Yongin-si (KR); Jun Seong IM, Ulsan (KR); Kye Hyun CHOI, Seoul (KR)

(72) Inventors: Ho Youn LEE, Seoul (KR); Jong Hyung YIM, Yongin-si (KR); Jun Seong IM, Ulsan (KR); Kye Hyun CHOI, Seoul (KR)

(73) Assignee: Hyundai Heavy Industries Co. Ltd., Ulsan (KR)

(21) Appl. No.: 14/828,363

(22) Filed: Aug. 17, 2015

(30) Foreign Application Priority Data
Sep. 3, 2014 (KR) 10-2014-0116777

(51) Int. Cl. E02F 9/22; F15B 11/17; F15B 11/20

(52) U.S. Cl. CPC E02F 9/2225; F15B 11/205; F15B 11/17; E02F 9/2292; E02F 9/2246; E02F 9/2296; F15B 2211/405

(57) ABSTRACT

Disclosed is a method of controlling work of an excavator. When a supply flow rate of hydraulic oil which is supplied to a working apparatus by a first pump among first and second pumps driven by the rotational force of the engine is higher than a requirement flow rate required by the working apparatus, the RPM of an engine is reduced, and hydraulic oil pumped by the first and second pumps are supplied to the working apparatus. Accordingly, an energy-saving effect such as a gas mileage of an excavator being reduced is obtained.

### CROSS-REFERENCE TO RELATED APPLICATIONS

This application claims the benefit of the Korean Patent Application No. 10-2014-0116777 filed on Sep. 3, 2014, which is hereby incorporated by reference as if fully set forth herein.

### BACKGROUND

1. Field of the Invention

The present invention relates to a method of controlling work of an excavator, in which when a supply flow rate of hydraulic oil supplied from one pump is higher than a requirement flow rate of hydraulic oil necessary for work of a working apparatus, the RPM(Revolution Per Minute) of an engine is reduced depending on the case, and work is performed at a supply flow rate of hydraulic oil supplied from two pumps.

2. Discussion of the Related Art

Construction machinery is a generic name for machineries which are used for an engineering work and a construction work, and examples of the construction machinery include various kinds of machineries such as excavators, bulldozers, forklift trucks, cranes, tower cranes, and/or the like. The construction machinery should move, have a small number of breakdowns, and have good durability.

In the construction machinery, excavators perform an excavating work that digs the ground with a machine shovel, a crushing work that crushes rock or concrete with a breaker, a grinding work that grinds a solid material, such as ore and/or the like, into an appropriate size with a crusher.

A working apparatus of an excavator that performs the excavating work, the crushing work, or the grinding work is supplied with hydraulic oil to perform work, and the hydraulic oil is pumped by a pump and is supplied to the working apparatus. To provide a detailed description, when the excavator starts, an engine is driven, a crankshaft rotates, and a rotational force of the crankshaft is transferred to the pump. Therefore, the pump pumps hydraulic oil stored in a tank to supply the hydraulic oil to the working apparatus, and thus, the working apparatus performs work.

Generally, excavators include two pumps that pump and supply hydraulic oil, and the two pumps are always driven.

To provide a detailed description, an excavator has started, and when a work mode to be performed is selected, a first pump and a second pump are driven and pump hydraulic oil to supply the hydraulic oil to a working apparatus.

In this case, if a flow rate of hydraulic oil supplied from the first pump to the working apparatus is sufficient, hydraulic oil pumped by the second pump is not supplied to the working apparatus but is transferred to and stored in a tank storing hydraulic oil. However, if the flow rate of the hydraulic oil supplied from the first pump to the working apparatus is insufficient, the hydraulic oil pumped by the second pump is supplied to the working apparatus along with the hydraulic oil pumped by the first pump.

That is, in a related art excavator, even when a flow rate of hydraulic oil that is pumped and supplied to the working apparatus by the first pump is sufficient for the working apparatus to perform work, the second pump is driven and pumps hydraulic oil without reducing the RPM(Revolution Per Minute) of an engine. For this reason, the related art excavator wastes energy.

Since the first pump and the second pump are driven with a rotational force of a crankshaft of the engine, it is very complicated to change the first pump and the second pump so as to be separately driven.

### SUMMARY

Accordingly, the present invention is directed to provide a method of controlling work of an excavator that substantially obviates one or more problems due to limitations and disadvantages of the related art.

An aspect of the present invention is directed to provide a method of controlling work of an excavator, which can solve all problems of the related art.

Another aspect of the present invention is directed to provide a method of controlling work of an excavator, in which when a supply flow rate of hydraulic oil that is pumped and supplied to a working apparatus by a first pump is sufficient for the working apparatus to perform work, the RPM(Revolution Per Minute) of an engine is reduced, and the working apparatus performs work at a supply flow rate of hydraulic oil supplied by the first pump and a second pump, thereby saving energy.

Additional advantages and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the invention, as embodied and broadly described herein, there is provided a method of controlling work of an excavator including: starting the excavator and selecting a work mode; comparing a requirement flow rate of hydraulic oil, required by a working apparatus having the selected work mode, with a first supply flow rate of hydraulic oil supplied to the working apparatus by a first pump which is driven by a rotational force transferred from an engine; when the first supply flow rate is lower than the requirement flow rate, adjusting a valve so that hydraulic oil pumped by a second pump driven by the rotational force transferred from the engine is supplied to the working apparatus along with the hydraulic oil pumped by the first pump, and when the first supply flow rate is equal to or higher than the requirement flow rate, determining whether a current mode is an ECO mode; and when the current mode is the ECO mode, adjusting the value so that the hydraulic oil pumped by the second pump and the hydraulic oil pumped by the first pump are supplied to the working apparatus, and subsequently reducing RPM(Revolution Per Minute) of the engine, and when the current mode is not the ECO mode, continuously supplying hydraulic oil corresponding to the first supply flow rate to the working apparatus by adjusting the valve.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates a structure where hydraulic oil is supplied to a working apparatus of an excavator according to an embodiment of the present invention; and

FIG. 2 is a flowchart illustrating a method of controlling work of an excavator, according to an embodiment of the present invention.

### DETAILED DESCRIPTION OF THE INVENTION

Reference will now be made in detail to the exemplary embodiments of the present invention, examples of which are illustrated in the accompanying drawings. Wherever possible, the same reference numbers will be used throughout the drawings to refer to the same or like parts.

In adding reference numerals for elements in each figure, it should be noted that like reference numerals already used to denote like elements in other figures are used for elements wherever possible.

Hereinafter, a method of controlling work of an excavator according to an embodiment of the present invention will be described in detail with reference to the accompanying drawings.

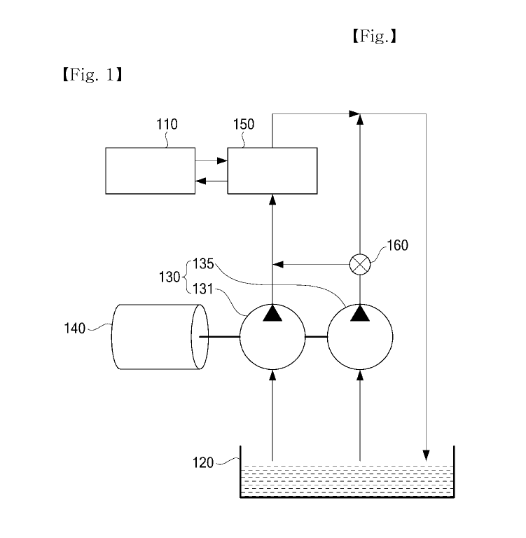

FIG. 1 illustrates a structure where hydraulic oil is supplied to a working apparatus of an excavator according to an embodiment of the present invention.

As illustrated, an excavator according to an embodiment of the present invention may include a working apparatus 110. Examples of the working apparatus 110 may include a machine shovel for excavating the ground, a breaker for crushing rock or concrete, and a crusher for grinding a solid material, such as ore and/or the like, into an appropriate size.

The working apparatus 110 may be supplied with hydraulic oil stored in a tank 120 to perform work, and the hydraulic oil stored in the tank 120 may be pumped and supplied to the working apparatus 110 by the pump 130. Also, the pump 130 may be supplied with a rotational force from an engine 140 and driven by the rotational force.

The pump 130 may compress and expand the hydraulic oil while rotating with a rotational force of a crankshaft (not shown) of the engine 140, and supply the hydraulic oil to the working apparatus 110.

Moreover, the pump 130 may compress and expand the hydraulic oil with a piston (not shown) that performs a rectilinear reciprocating motion with the rotational force of the crankshaft of the engine 140, and supply the hydraulic oil to the working apparatus 110. In this case, in order for the piston to perform the rectilinear reciprocating motion, a force conversion unit (not shown) that converts the rotational force of the engine 140 into a rectilinear motion may be installed between the engine 140 and the piston of the pump 130.

The pump 130 may include a first pump 131 and a second pump 135. When the working apparatus 110 is performing work, the first pump 131 and the second pump 135 may be always driven together.

A control unit 150 such as a spool may be installed in a flow path between the first pump 131 and the working apparatus 110. The control unit 150 may control a flow rate or a pressure of hydraulic oil supplied from the first pump 131 to the working apparatus 110, and the hydraulic oil used for work of the working apparatus 110 may be again transferred to the tank 120 through the control unit 150.

Hydraulic oil supplied by the second pump 135 may be supplied to the control unit 150, or may be again transferred to the tank 120. To this end, a valve 160 that selectively supplies the hydraulic oil supplied by the second pump 135 to the control unit 150 or supplies the hydraulic oil to the tank 120 may be provided.

When the second pump 135 is connected to the control unit 150 by the valve 160, the hydraulic oil supplied by the second pump 135 and the hydraulic oil supplied by the first pump 131 may be supplied to the control unit 150 and then supplied to the working apparatus 110. Also, when the second pump 135 is connected to the tank 120 by the valve 160, the hydraulic oil supplied by the second pump 135 may be supplied to the tank 120.

In the first pump 131 and the second pump 135 that compress and expand the hydraulic oil while rotating, an swash plate (not shown) for adjusting a compression amount and an expansion amount of the hydraulic oil may be installed in each of the first pump 131 and the second pump 135. The swash plate may be provided to adjust an angle with respect to each of the first pump 131 and the second pump 135, and a compression amount and an expansion amount of the hydraulic oil compressed and expanded by each of the first pump 131 and the second pump 135 may be adjusted according to an angle of the swash plate.

When an angle of the swash plate of each of the first and second pumps 131 and 135 is large, a much amount of hydraulic oil may be supplied to the working apparatus 110, and when an angle of the swash plate of each of the first and second pumps 131 and 135 is small, a small amount of hydraulic oil may be supplied to the working apparatus 110

In the first pump 131 and the second pump 135 that compress and expand the hydraulic oil by using the rectilinear reciprocating motion of the piston, the swash plate may be provided in the piston between the engine 140 and the first pump 131, and the swash plate may be provided in the piston between the engine 140 and the second pump 135. The swash plate may be installed to adjust an angle with respect to each of the pistons of the first and second pumps 131 and 135, and sliding distances of the pistons of the first and second pumps 131 and 135 may be respectively adjusted according to angles of the swash plates.

When the sliding distances of the pistons of the first and second pumps 131 and 135 are long, a much amount of hydraulic oil may be supplied to the working apparatus 110, and when the sliding distances of the pistons of the first and second pumps 131 and 135 are short, a small amount of hydraulic oil may be supplied to the working apparatus 110.

As described above, the hydraulic oil used for driving of the working apparatus 110 may be again transferred to the tank 120 through the control unit 150.

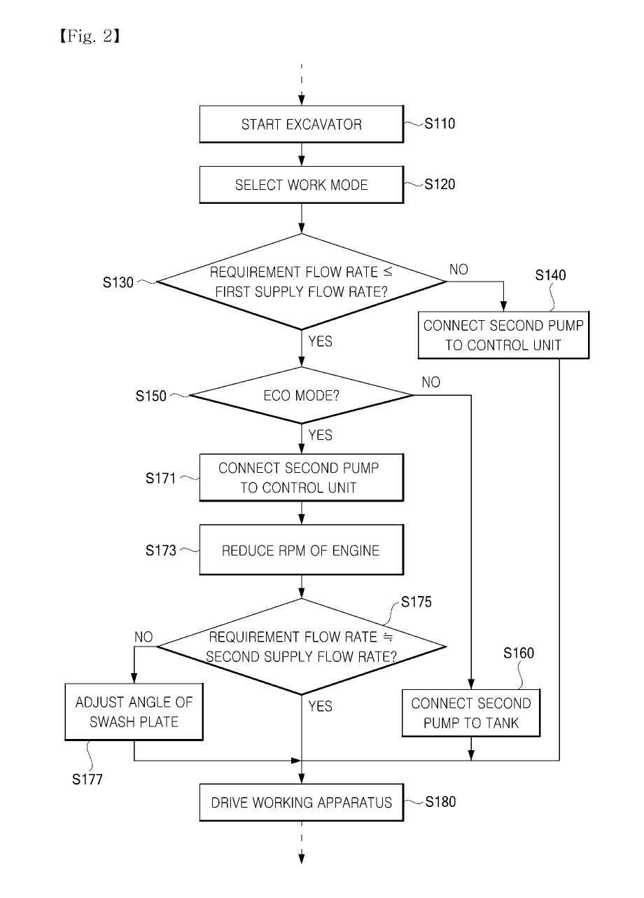

A method of controlling work of an excavator according to an embodiment of the present invention will be described in detail with reference to FIGS. 1 and 2. FIG. 2 is a flowchart illustrating a method of controlling work of an excavator, according to an embodiment of the present invention.

As illustrated, in operation S110, an excavator may start and may be in a drivable state. In operation S120, the method may select a work mode such as an excavating work that digs the ground with a machine shovel, a crushing work that crushes rock or concrete with a breaker, or a grinding work that grinds a solid material, such as ore and/or the like, into an appropriate size with a crusher

Subsequently, in operation S130, the method may compare a requirement flow rate of hydraulic oil, required by the working apparatus 110 having the selected work mode, with a first supply flow rate of hydraulic oil supplied from the first pump 131 to the working apparatus 110. Flow rates of hydraulic oil required by the working apparatus 110 may differ in the excavating work, the crushing work, and the grinding work, and a flow rate of hydraulic oil required by the working apparatus 110 for each of the works may be set by repeatedly undergoing a number of trails and errors.

Therefore, when the first supply flow rate is lower than the requirement flow rate, the second pump 135 may be connected to the control unit 150 by the valve 160 in operation S140, and the hydraulic oil supplied by the second pump 135 and the hydraulic oil supplied by the first pump 131 may be supplied to the working apparatus 110.

However, when the first supply flow rate is higher than the requirement flow rate, whether a current mode is an ECO mode may be determined in operation S150.

After performing operation S150 of determining whether the current mode is the ECO mode, when the current mode is not the ECO mode, the second pump 135 may be connected to the tank 120 by the value 160 in operation S160, and thus, only hydraulic oil pumped by the first pump 131 may be supplied to the working apparatus 110. Since the first supply flow rate of the hydraulic oil supplied by the first pump 131 is equal to or higher than the requirement flow rate required by the working apparatus 110, the working apparatus 110 may perform work at only the first supply flow rate. Also, since the second pump 135 is connected to the tank 120, hydraulic oil pumped by the second pump 135 may be again transferred to the tank 120.

After performing operation S150 of determining whether the current mode is the eco mode, operations of lowering the first supply flow rate of hydraulic oil which is supplied at the requirement flow rate or more may be performed.

When the current mode is the ECO mode, the second pump 135 may be connected to the control unit 150 by the valve 160 in operation S171, and the hydraulic oil supplied by the second pump 135 and the hydraulic oil supplied by the first pump 131 may be supplied to the working apparatus 110. However, in a state where only the first supply flow rate itself of the hydraulic oil supplied by the first pump 131 is equal to or higher than the requirement flow rate, if the hydraulic oil pumped by the second pump 135 is further supplied to the working apparatus 110 through the control unit 150, a second supply flow rate of hydraulic oil which is pumped by the first and second pumps 131 and 135 and supplied to the working apparatus 110 through the control unit 150 may be far higher than the requirement flow rate.

Therefore, after the second pump 135 is connected to the control unit 150 by the valve 160 in operation S171, operation S173 of reducing the RPM(Revolution Per Minute) of the engine 140 may be performed for lowering the second supply flow rate.

Subsequently, the method may compare the requirement flow rate with the second supply flow rate to calculate a difference therebetween in operation S175, and when the difference between the requirement flow rate and the second supply flow rate is less than a predetermined value, the working apparatus 110 may be driven by supplying hydraulic oil corresponding to the second supply flow rate in operation S180.

However, when the difference between the requirement flow rate and the second supply flow rate is equal to or greater than the predetermined value, this may denote that the second supply flow rate is too lower than or too higher than the requirement flow rate. Therefore, operation S177 of adjusting an angle of the swash plate may be performed.

In the first pump 131 and the second pump 135 that compress and expand the hydraulic oil while rotating, when the second supply flow rate is lower than the requirement flow rate and the difference between the requirement flow rate and the second supply flow rate is equal to or greater than the predetermined value, a much amount of hydraulic oil may be supplied to the working apparatus 110 by broadening the angle of the swash plate. On the other hand, when the second supply flow rate is higher than the requirement flow rate and the difference between the requirement flow rate and the second supply flow rate is equal to or greater than the predetermined value, a small amount of hydraulic oil may be supplied to the working apparatus 110 by narrowing the angle of the swash plate.

In the first pump 131 and the second pump 135 that compress and expand the hydraulic oil by using the pistons, the sliding distances of the pistons may be respectively adjusted by adjusting the angles of the swash plates. When the second supply flow rate is lower than the requirement flow rate and the difference between the requirement flow rate and the second supply flow rate is equal to or greater than the predetermined value, the angles of the swash plates may be respectively adjusted to increase the sliding distances of the pistons of the first and second pumps 131 and 135. On the other hand, when the second supply flow rate is higher than the requirement flow rate and the difference between the requirement flow rate and the second supply flow rate is equal to or greater than the predetermined value, the angles of the swash plates may be respectively adjusted to decrease the sliding distances of the pistons of the first and second pumps 131 and 135.

If a correlation between a change in the second supply flow rate and a change in the angles of the swash plates based on the RPM of the engine 140 is set by repeatedly undergoing a number of trials and errors, the angles of the swash plates may be appropriately adjusted.

In the method of controlling work of an excavator according to an embodiment of the present invention, when the second supply flow rate of hydraulic oil which is supplied to the working apparatus by the first and second pumps 131 and 135 driven by the rotational force of the engine 140 is higher than the requirement flow rate required by the working apparatus 110, the RPM of the engine is reduced, thereby saving energy.

In the method of controlling work of an excavator according to the embodiment of the present invention, when a supply flow rate of hydraulic oil which is supplied to the working apparatus by the first pump among the first and second pumps driven by the rotational force of the engine is higher than a requirement flow rate required by the working apparatus, the RPM of the engine is reduced, and hydraulic oil pumped by the first and second pumps are supplied to the working apparatus. Accordingly, an energy-saving effect such as a gas mileage of an excavator being reduced is obtained.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of controlling work of an excavator, the method comprising:
starting the excavator and selecting a work mode;
comparing a requirement flow rate of hydraulic oil, required by a working apparatus having the selected work mode, with a first supply flow rate of hydraulic oil supplied to the working apparatus by a first pump which is driven by a rotational force transferred from an engine;
when the first supply flow rate is lower than the requirement flow rate, adjusting a valve so that hydraulic oil pumped by a second pump driven by the rotational force transferred from the engine is supplied to the working apparatus along with the hydraulic oil pumped by the first pump, and when the first supply flow rate is equal to or higher than the requirement flow rate, determining whether a current mode is an ECO mode; and
when the current mode is the ECO mode, adjusting the value so that the hydraulic oil pumped by the second pump and the hydraulic oil pumped by the first pump are supplied to the working apparatus, and subsequently reducing RPM (Revolution Per Minute) of the engine, and when the current mode is not the ECO mode, continuously supplying hydraulic oil corresponding to the first supply flow rate to the working apparatus by adjusting the valve.

2. The method of claim 1, further comprising:
after reducing the RPM of the engine,
comparing the requirement flow rate with a second supply flow rate of hydraulic oil supplied to the working apparatus by the first and second pumps; and
when a difference between the requirement flow rate and the second supply flow rate is less than a predetermined value, supplying hydraulic oil corresponding to the second supply flow rate to the working apparatus, and when the difference between the requirement flow rate and the second supply flow rate is equal to or higher than the predetermined value, adjusting an angle of an swash plate to adjust the second supply flow rate, the swash plate adjusting a compression amount and an expansion amount of hydraulic oil which is compressed and expanded by each of the first and second pumps.

3. The method of claim 2, wherein
the first pump and the second pump compress and expand the hydraulic oil while rotating with the rotational force of the engine,
the swash plate is installed in each of the first pump and the second pump, and
when the second supply flow rate is lower than the requirement flow rate and the difference between the requirement flow rate and the second supply flow rate is equal to or greater than the predetermined value, the second supply flow rate increases by broadening the angle of the swash plate.

4. The method of claim 2, wherein
the first pump and the second pump compress and expand the hydraulic oil while rotating with the rotational force of the engine,
the swash plate is installed in each of the first pump and the second pump, and
when the second supply flow rate is higher than the requirement flow rate and the difference between the requirement flow rate and the second supply flow rate is equal to or greater than the predetermined value, the second supply flow rate is reduced by narrowing the angle of the swash plate.

5. The method of claim 2, wherein
the first pump and the second pump compress and expand the hydraulic oil while rotating with the rotational force of the engine,
the swash plate is installed in each of the first pump and the second pump,
when the second supply flow rate is lower than the requirement flow rate and the difference between the requirement flow rate and the second supply flow rate is equal to or greater than the predetermined value, the second supply flow rate increases by broadening the angle of the swash plate, and
when the second supply flow rate is higher than the requirement flow rate and the difference between the requirement flow rate and the second supply flow rate is equal to or greater than the predetermined value, the second supply flow rate is reduced by narrowing the angle of the swash plate.

6. The method of claim 2, wherein
each of the first pump and the second pump compresses and expands the hydraulic oil by using a piston that performs a rectilinear reciprocating motion with the rotational force of the engine,
one swash plate is provided between the engine and the piston of the first pump, and another swash plate is provided between the engine and the piston of the second pump, and
when the second supply flow rate is lower than the requirement flow rate and the difference between the requirement flow rate and the second supply flow rate is equal to or greater than the predetermined value, the second supply flow rate increases by respectively adjusting angles of the swash plates for sliding distances of the pistons to increase.

7. The method of claim 2, wherein
each of the first pump and the second pump compresses and expands the hydraulic oil by using a piston that performs a rectilinear reciprocating motion with the rotational force of the engine,
one swash plate is provided between the engine and the piston of the first pump, and another swash plate is provided between the engine and the piston of the second pump, and
when the second supply flow rate is higher than the requirement flow rate and the difference between the requirement flow rate and the second supply flow rate is equal to or greater than the predetermined value, the second supply flow rate is reduced by adjusting the angle of the swash plate for a sliding distance of a piston to decrease.

8. The method of claim 2, wherein
each of the first pump and the second pump compresses and expands the hydraulic oil by using a piston that performs a rectilinear reciprocating motion with the rotational force of the engine,
one swash plate is provided between the engine and the piston of the first pump, and another swash plate is provided between the engine and the piston of the second pump,
when the second supply flow rate is lower than the requirement flow rate and the difference between the requirement flow rate and the second supply flow rate is equal to or greater than the predetermined value, the second supply flow rate increases by respectively adjusting angles of the swash plates for sliding distances of the pistons to increase, and
when the second supply flow rate is higher than the requirement flow rate and the difference between the requirement flow rate and the second supply flow rate is equal to or greater than the predetermined value, the second supply flow rate is reduced by adjusting the angle of the swash plate for a sliding distance of a piston to decrease.
